(19) United States
(12) Patent Application Publication
(10) Pub. No.: US 2026/0209439 A1
(43) Pub. Date: Jul. 23, 2026

(54) IMIDE COMPOSITION AND PRESERVATIVE COMPOSITION COMPRISING THE IMIDE COMPOSITION

(71) Applicant: AKTIEBOLAGET SKF, GOTEBORG (SE)

(72) Inventors: Amra CENANOVIC, Hisings Backa (SE); Frank FIDDELAERS, Gorinchem (NL); Remko THIJSSEN, Oss (NL); Albert VAN DEN KOMMER, Nieuwegein (NL); Roel VAN DER ZWAAN, Ter Aar (NL)

(21) Appl. No.: 19/566,276

(22) Filed: Mar. 13, 2026

Related U.S. Application Data
(63) Continuation of application No. 18/215,962, filed on Jun. 29, 2023.
Application No. 18/215,962 is a continuation of application No. 16/822,314, filed on Mar. 18, 2020.

(30) Foreign Application Priority Data
May 7, 2019 (DE) 102019206559.7

(51) Int. Cl. C08G 73/10; C09D 5/08; C09D 179/08

(52) U.S. Cl. CPC C08G 73/1085; C08G 73/1032; C09D 5/08; C09D 179/08

(57) ABSTRACT

An imide composition obtainable by providing (a) reacting a dianhydride with a diamine in the presence of a solvent at a temperature in the range of from 20-80° C. The molar ratio of the dianhydride to the diamine is from 0.25-4, forming an imide precursor; and (b) subjecting the imide precursor as formed in step (a) in the presence of a solvent to a heat treatment carried out at a temperature from 80-150° C. to convert the imide precursor into an imide, thereby forming the imide composition. Also, a preservative composition including the present imide composition; a metal article having a coating that provides the present preservative composition; a process for preparing the imide composition; the use of the present imide composition to prevent and/or reduce false brinelling in a roll bearing system; and the use of the present preservative composition to prevent and/or reduce false brinelling in a roll bearing system.

### CROSS-REFERENCE TO RELATED APPLICATIONS

This application claims priority to German Patent Application no. 102019206559.7, filed May 7, 2019, the contents of which is fully incorporated herein by reference.

### FIELD OF THE INVENTION

The present invention relates to an imide composition; a preservative composition comprising the imide composition; a metal article having a coating thereon which coating comprises the imide composition or the preservative composition; a process for preparing the imide composition; a process for forming a coating on a metal article; the use of the imide composition to prevent and/or reduce false brinelling in a roll bearing system the use of preservative composition to prevent and/or reduce false brinelling in a roll system.

### BACKGROUND OF THE INVENTION

Preservative compositions are widely used to protect bearings and other structural components against damages which are the result of for instance corrosion, wear and surface cracking initiation. Damages to bearings and roll bearing systems will affect their performance and functioning during life time at the operating conditions and affects the bearing life.

A common type of bearing damage is fretting. Fretting refers to any situation in which the mating surfaces are subjected to small amplitude reciprocating sliding or rolling motions. Fretting can occur between mating surfaces which are intended to be fixed but are subjected to small oscillating motions to due vibration. In various applications, bearings in housings or bearing on shafts, can be subjected to dynamic loads or bending moments introducing small amplitudes of small amplitudes of relative motion. Fretting can cause seizure, can amplify vibrations, cause wear and fatigue of the components and might eventually lead to failure of the system. Fretting is characterized by the fact that the wear debris stays entrapped in the contact due to the small vibration amplitudes of fretting. In conventional atmospheres, oxidation of the debris is involved and the terms fretting corrosion and fretting wear are often applied. The term false brinelling is specifically used for fretting of point contacts in ball bearings.

Bearings of passenger cars can be subjected to small oscillating motions and as a result could reveal false brinelling after car transportation. The appearance of fretting in a ball-on-ring contact resembles a Brinell indentation used in hardness measurements of bulk materials, hence false brinelling. System vibrations and/or cyclic loading, can both result in relative sliding of the mating surfaces over each other and within these aspects two different terminologies are being used.

Often a distinction is made between fretting wear and fretting fatigue. Fretting fatigue generally refers to dynamic bulk stresses including tensile stressing of the component. Fretting conditions induce crack initiation and propagation at stresses below the fatigue limit of the component. Fretting wear and fatigue can both involve dynamic loads. Fretting wear is an adhesive wear mechanism. The difference between fretting wear and fatigue is the dominance in which the dynamic bulk stresses (those resulting in tensile stresses) are participating in the failure mode relatively to (dynamic) shear stresses. Such tensile stress can be responsible for through cracking of the component. The shear stresses decrease rather rapidly with the distance beneath the surface and in the absence of tensile bulk stresses, cracking is restricted to shallow surface regions. Under these conditions, fretting wear overshadows fretting fatigue and cracking becomes limited to shallow depths.

Another common type of bearing damage is frictional corrosion which occurs in the form of a chemical reaction which is activated by relative micro movements between contacting surfaces under certain conditions inside a bearing. The frictional corrosion takes place in the form of fretting corrosion or vibration corrosion.

Fretting corrosion occurs when there is a relative movement between a bearing ring and shaft or housing, because e.g. the fit is too loose, or too tight. Due to relative movement between the mating surfaces small particles of material may become detached from the surface, and these particles may oxidize quickly when exposed to the oxygen in the atmosphere.

Vibration corrosion, also called false brinelling, occurs in in rolling element-raceway contact areas due to micro-movements and/or resilience of the elastic contact under cyclic vibrations. Depending on the intensity of the vibrations, the lubricating condition and load, a combination of corrosion and wear occurs, forming shallow depressions in the raceway. In the case of a stationary bearing, e.g. bearings during transportation of passenger cars, the depressions appear at rolling element pitch and can often be discolored or shiny. Bearing and other metal components are subjected to machining processes, cleaning, heating and other chemical treatments and can face during its production processes various chemical and corrosion aggressive compounds from which the metal surfaces need to be protected.

Rust preventives and corrosion inhibitors are providing resistance to these corrosion promoting fluids and environments. After manufacturing the bearing surface can be dipped or sprayed into a preservative fluid. A temporary protecting film can protect the metal and bearing surface against corrosion during shipment and storage of the metal component. A corrosion inhibitor can be applied as an additive in a lubrication oil or grease or even as part of a processing fluid. As long as the carrying fluid or grease is able to make a film over the metal surface than the corrosion inhibitor task is to prevent the surface from corrosion. Rust preventives are usually composed from additives dissolved in a medium. The medium can be as much as 80 wt. % or even higher present in the preservative composition. Popular media are solvents, naphthenic or paraffinic oils.

Solvents can have the capacity to completely evaporate while oils usually do not fully evaporate after application and oily films remain on the surface. Water can partially or fully evaporate and as a result could still be part of the final film even after application or drying. Examples of additives used in preservatives are metal salts, waxes, oils, petroleum based products, mineral spirits or other types of additives. Waxes and metal salts are commonly applied as ingredients in the preservatives. Typical examples of metal salts are calcium, barium, sodium sulfonate salts. The use of these typical metal salts do not have fully satisfying corrosion protection and require the need of waxes. Some of these metals salts have their limitation either in use due to their stringent safety and environmental legislations or simply due to their poor corrosion resistance. Waxes are prone to quality inconsistency, unstable crystallinity and can show issues with sprayability.

Conventional preservative compositions are usually composed of metal-containing compounds and waxes. Typical metal-containing compounds used for this purpose are calcium sulfonate salts that are incorporated in the solvent or oil. Another drawback of conventional preservative compositions is the fact that their effectiveness leaves considerable room for improvement.

Object of the present invention is to provide new approach to attractively prevent and/or reduce false brinelling in which no use is made of metal salts and waxes. This new approach is based on the preparation of a new chemical composition which displays excellent anti-false brinelling properties.

Another object of the present invention is to provide a preservative composition which comprises the new chemical composition.

### SUMMARY OF THE INVENTION

Surprisingly, it has now found that a particular imide composition prevents and/or reduces false brinelling in an excellent manner.

Accordingly, the present invention provides an imide composition which is obtainable by a process which comprises the steps of:
(a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor; and
(b) subjecting at least part of the imide precursor as formed in step (a) in the presence of a solvent to a heat treatment which is carried out at a temperature in the range of from 80-150° C. to convert at least part of the imide precursor into an imide, thereby forming the imide composition.

The imide composition in accordance with the present invention displays unique properties in terms of false brinelling prevention and/or reduction. The present imide composition prevents and/or reduces false brinelling in an improved way when compared to conventional preservative compositions that contain calcium sulfonate salts.

### BRIEF DESCRIPTION OF THE DRAWINGS

The patent or application file contains at least one drawing executed in color. Copies of this patent or patent application publication with color drawings will be provided by the Office upon request and payment of the necessary fee. The invention will be understood better from reading the following description, which is given solely by way of non-limiting example.

FIG. 1 is a graph illustrating IR spectra of the embodiments of the invention;

FIG. 2 is a graph illustrating performance differentiation of a first embodiment of the present invention;

FIG. 3 is a graph illustrating performance differentiation of Example 2 of the present invention; and

FIG. 4 is a graph illustrating performance differentiation of Example 3 of the present invention.

### DETAILED DESCRIPTION OF THE INVENTION

The imide composition according to the present invention is obtainable by a process which comprises a step (a) and a step (b).

In step (a), a dianhydride is reacted with a diamine in the presence of a solvent at a temperature in the range of from 20-80° C.

Suitably, the dianhydride used in step (a) is selected from the group consisting of pyromellitic dianhydride, perylene tetracarboxylic dianhydride, 4,4′oxydiphthalidianhydride, 4,4-bisphenol A dianhydride, bisphenol diether dianhydride, 4,4′-(4,4′-isopropylidenediphenoxy) bis (phthalic anhydride), naphthalene tetracarboxylic dianhydride, ethylene dianhydride, naphthalene dianhydride, phenanthrene dianhydride, anthracene dianhydride and benzoquinonetatracarboxylic dianhydride. Most preferably, the dianhydride is pyromellitic dianhydride.

Suitably, the diamine used in step (a) is selected from the group consisting of aliphatic linear unbranched, branched, or cyclic diamines, unsaturated diamines, aromatic diamines, diamines not directly attached to the aromatic rings, e.g. benzenemethanamine, diphenyl diamine, dinaphthalenediamine, and hexamethylenediamine. Preferably, the diamine is selected from the group consisting of dodecanediamine, diaminodecane, ethylenediamine, butanediamine, diamineoctane, methanediamine and hexamethylenediamine. More preferably, the diamine is hexamethylenediamine.

Step (a) is carried out at a temperature in the range of from 20-80° C., preferably in the range of from 40-60° C., and more preferably in the range of from 45-55° C.

In step (a), a solvent is present. Preferably, the solvent is selected from the group consisting of polar solvents, non-polar solvents and aprotic polar solvents. Suitable examples of polar solvents include formic acid, n-butanol, isopropanol, nitromethane, ethanol, methanol, acetic acid and water. Suitable examples of non-polar solvents include hexane, benzene, toluene, 1,4-dioxane, chloroform and diethyl ether. Suitable solvents of aprotic solvents include dichloromethane, N-methylpyrrolidone, tetrahydrofuran, ethyl acetate, acetone, dimethylformamide, acetonitrile, dimethyl sulfoxide and propylene carbonate. Preferred solvents to be used in accordance with the present invention include dimethyl sulfoxide, acetone, chloroform, ethyl ether, n-hexane, benzene, N-methyl-2-pyrrolidone, dimethylformamide, dimethylacetamide, N-methyl-2-pyrolidone and water.

In step (a), a single solvent or a mixture of solvents can be used. Suitably, the solvent is present in an amount such that the weight ratio of the sum of the dianhydride (A) and the diamine (B) to the solvent (C) is in the range of from 0.005-0.5 ((A+B)/C), preferably in the range of from 0.01-0.1 (A+B/C).

At least part of the imide precursor as formed in step (a) is subjected to step (b). Preferably, the entire imide precursor as formed in step (a) is subjected to step (b).

At least part of the imide precursor as formed in step (a) can be subjected to a heat treatment before it is subjected to step (b). Preferably, the entire amount of imide precursor as formed in step (a) is subjected to heat treatment before it is subjected to step (b). In such a heat treatment the solvent used in step (a) can be evaporated to obtain the imide precursor in powder form. Such a heat treatment can suitably be carried out at a temperature in the range of from 40-200° C., preferably in the range of from 80-150° C. Subsequently, the imide precursor so obtained can be mixed with the solvent in step (b).

Accordingly, the present invention also provides an imide composition which is obtainable by a process which comprises the steps of:
(a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor;
(b) subjecting at least part of the imide precursor as formed in step (a) to a heat treatment; and
(c) subjecting at least part of the imide precursor as obtained in step (b) in the presence of a solvent to a heat treatment which is carried out at a temperature in the range of from 80-150° C. to convert at least part of the imide precursor into an imide, thereby forming the imide composition.

Preferably, the entire amount of imide precursor formed in step (a) is subjected to step (b).

Preferably, the entire amount of imide precursor as obtained in step (b) is subjected to step (c).

In step (a), the molar ratio of the dianhydride (A) to the diamine (B) is in the range of from 0.25-4 (A/B), preferably in the range of from 0.33-1 (A/B), and more preferably in the range of from 0.45-1 (A/B).

In step (a), the solubility of the dianhydride is suitably in the range of from 0.0006-1 grams per milliliter of solvent.

In step (a), the solubility of the diamine is suitably in the range of from 0.0006-1 grams per milliliter of solvent.

Preferably, in step (a) the dianhydride is pyromellitic dianhydride and the diamine is hexamethylenediamine.

In step (a), an imide precursor is formed which is in step (b) converted into an imide, thereby forming the imide composition in accordance with the present invention. In case pyromellitic dianhydride and a diamine are used, the imide precursor will have the following general formula (I)

### (I)

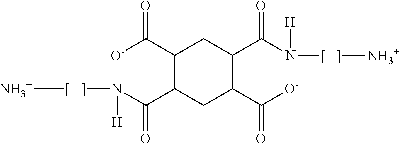

The NH3+ group as shown in general formula (I) can also in the same molecule be NH2 group. Some molecules of general formula (I) contain NH3+ groups and other molecules contain NH2.

In step (a), the pH is suitably in the range of from 5-9, preferably in the range of from 6-8. The Total Acid Number (TAN) is maximum 200 and the Total Base Number (TBN) is maximum 200.

In step (b), at least part of the imide precursor as formed in step (a) is subjected in the presence of a solvent to a heat treatment which is carried out at a temperature in the range of from 80-150° C. to convert at least part of the imide precursor into an imide, thereby forming the imide composition.

Preferably, the heat treatment is carried out at a temperature in the range of from 110-130° C., more preferably in the range of from 115-125° C.

In step (b), a solvent is present. Preferably, the solvent is selected from the group consisting of polar solvents, non-polar solvents and aprotic polar solvents. Suitable examples of polar solvents include formic acid, n-butanol, isopropanol, nitromethane, ethanol, methanol, acetic acid and water. Suitable examples of non-polar solvents include hexane, benzene, toluene, 1,4-dioxane, chloroform and diethyl ether. Suitable solvents of aprotic solvents include dichloromethane, N-methylpyrrolidone, tetrahydrofuran, ethyl acetate, acetone, dimethylformamide, acetonitrile, dimethyl sulfoxide and propylene carbonate.

Preferred solvents to be used in accordance with the present invention include dimethyl sulfoxide, acetone, chloroform, ethyl ether, n-hexane, benzene, N-methyl-2-pyrrolidone, dimethylformamide, dimethylacetamide, N-methyl-2-pyrolidone and water.

In step (b), a single solvent or a mixture of solvents can be used.

Suitably in step (b) the solvent is present in an amount such that the weight ratio of the imide precursor (D) to the solvent (E) is in the range of from 0.001-1 (D/E), preferably in the range of from 0.01-0.5 (D/E). In step (b), the pH is suitably in the range of from 5-9, preferably in the range of from 6-8. The Total Acid Number (TAN) is maximum 200 and the Total Base Number (TBN) is maximum 200. In steps (a) and (b) the same or different solvents can be used. Suitably, step (a) is carried out in the presence of an aprotic polar solvent, and step (b) is carried out in the presence of a polar solvent and/or an aprotic solvent.

In this step (b) different solvents can be used at different stages of this step. For instance in a first stage of step (b) a mixture of different solvents can be used whereas, at a second stage of step (b) solvents can be used such as N-methyl-2-pyrrolidone followed within step (b) with water. This approach has the advantage that the false brinelling performance is influenced in a positive way.

The imide formed during step (b) can be subjected to an evaporation treatment in which a first solvent to be used in step (b) will be removed to obtain a dry powder of the imide. Subsequently, a second solvent such as water can be added to the dry imide powder.

In a particular embodiment of the present invention, the imide precursor formed in step (a) can be applied on a surface of a metal article. This can for example be done by brushing dipping, spraying, whipping or rubbing the imide precursor in liquid form (i.e. dissolved in a solvent) onto the surface of the metal article. The metal surface can be pre-heated to the targeted process temperature of step (b) or after application onto the metal surface the coating formed with the imide precursor will be heated to the targeted temperature of step (b).

Accordingly, the present invention also provides a process for forming a coating on a surface of a metal article comprising the steps of: (a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor;
(b) heating the surface of the metal article to a temperature in the range of from 80-150° C.; and
(c) applying at least part of the reaction mixture as obtained in step (a) or at least part of the imide precursor as formed in step (a) and dissolved in a solvent to the surface of the metal article to form a coating thereon, thereby forming the coating of the imide composition on the surface of the metal article.

The present invention also provides a process for forming a coating on a surface of a metal article comprising the steps of:
(a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor;
(b) applying at least part of the reaction mixture as obtained in step (a) or at least part of the imide precursor as formed in step (a) and dissolved in a solvent onto the surface of the metal article to form a coating thereon; and
(c) and subjecting the coating as formed in step (b) to a heat treatment to convert at least part of the imide precursor into an imide, thereby forming a coating which contains the imide on the surface of the metal article.

In case pyromellitic dianhydride and a diamine are used the imide—as formed in step (b) will have the following general formula (II):

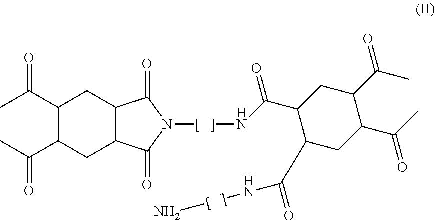

In step (b), three additional imide precursors will be formed of which the structure differs from the imide precursor which is formed in step (a). These three additional imide precursors will typically have the following general formulae (III), (IV) and (V).

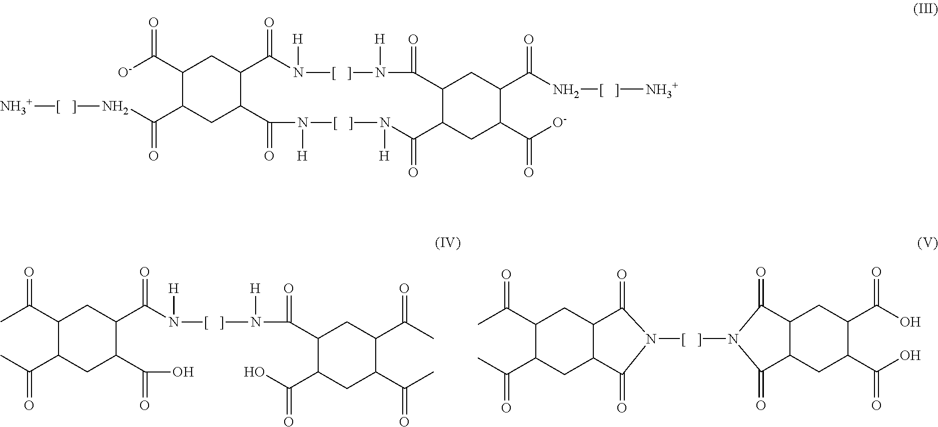

Suitably, the imide composition in accordance with the present invention comprises the imide, the imide precursor as formed in step (a), the three additional imide precursors that are formed in step (b), and solvent that was present in step (a) and/or step (b). After step (b), the imide composition will usually be cooled down to ambient temperature before it will be used as a preservative composition.

When the imide composition is applied to a metal article such as a bearing, under operating conditions heat will be generated as a result of which unreacted imide precursor as obtained in step (a) and which is present in the imide composition can be converted into the imide and this imide can form a coating on the bearing during its operation. In addition, under such operating conditions, the imide and the three additional imide precursors will eventually also be converted into a polyimide of general formula (VI) whereby the polyimide obtained will form a coating on the bearing surface.

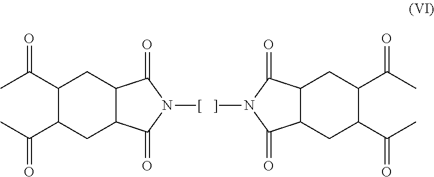

The present invention also provides a preservative composition which comprises the imide composition in accordance with the present invention. In addition to the present imide composition, the preservative composition may contain known additives such as rust preventives and corrosion inhibitors. The imide composition and preservative compositions may also contain lanoline, and one or more waxes.

The preservative composition according to the present invention also includes anti-rust preservative compositions and an anti-corrosion preservative composition.

Suitably, the preservative composition comprises 0.2-50 wt. % of the imide composition, preferably at least 0.5-40 wt. % of the imide composition, and more preferably at least 0.5-30 wt. % of the imide composition, based on the total weight of the preservative composition.

Typical techniques to apply preservative compositions on metal surfaces such as bearing surfaces are dipping, spraying, brushing or any other techniques that physically or mechanically apply the preservative composition onto the surface. This can be established by using for instance a roller or a wiper. Before the preservative composition has been applied onto the surface it is possible to apply a pre-cleaning or washing step in order to remove oil residues and water residues from the metal surface. The pre-cleaning step is then followed by applying the preservative composition onto the surface.

The present invention also provides a process for preparing an imide composition, comprising the steps of:
(a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor; and
(b) subjecting at least part of the imide precursor as formed in step (a) in the presence of a solvent to a heat treatment which is carried out at a temperature in the range of from 80-150° C. to convert at least part of the imide precursor into an imide, thereby forming the imide composition.

Preferably, the entire amount of imide precursor as formed in step (a) is subjected to step (b).

The present invention also provides a process for preparing an imide composition, comprising the steps of:
(a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor;
(b) subjecting at least part of the imide precursor as formed in step (a) to a heat treatment; and
(c) subjecting at least part of the imide precursor as obtained in step (b) in the presence of a solvent to a heat treatment which is carried out at a temperature in the range of from 80-150° C. to convert at least part of the imide precursor into an imide, thereby forming the imide composition. Preferably, the entire amount of imide precursor as formed in step (a) is subjected to step (b). Preferably, the entire amount of imide precursor as obtained in step (b) is subjected to step (c).

The present invention also relates to a metal article having a coating thereon which coating comprises the present imide composition or the preservative composition according to the present invention. Suitably, the metal component is a component of a linear motion system, a rolling element, a plain bearing, a ball bearing, a roller bearing, a gear or a coupling. Preferably, the metal article is a bearing. An advantage of the imide composition according to the present invention is that it has very attractive film forming properties which allows for excellent coatings to be formed on the metal articles.

Suitably, the coating has a thickness in the range of from 0.5-40 micron, preferably a thickness in the range of from 2-20 micron. The thickness of the coating can be measured by known technologies. For instance, specific plates of a certain weight as received (having no coating or no preservative) and weight of the same plates that are treated with the preservative or coating are determined, enabling one to calculate the weight difference. Since, the surface area is known exactly, it is possible to calculate the coating or preservative film thickness

The present invention also provides a process for forming a coating on a surface of a metal article comprising the steps of:
(a) reacting a dianhydride with a diamine in the presence of a solvent at a temperature in the range of from 20-80° C., wherein the molar ratio of the dianhydride (A) to the diamine (B) is in the range of from 0.25-4 (A/B), thereby forming an imide precursor;
(b) subjecting at least part of the imide precursor as formed in step (a) in the presence of a solvent to a heat treatment which is carried out at a temperature in the range of from 80-150° C. to convert at least part of the imide precursor into an imide, thereby forming the imide composition; and
(c) applying at least part of the imide composition as formed in step (b) onto the surface of the metal article to form a coating thereon.

Preferably, the entire amount of imide precursor as formed in step (a) is subjected to step (b).

In addition, the present invention relates to the use of the present imide composition preventing and/or reducing false brinelling in a roll bearing system.

The imide composition or preservative composition according to the present invention can be used to prevent and/or reduce fretting or false brinelling and/or standstill corrosion, stress corrosion cracking or any other form of corrosion for components, surfaces or metal articles like housing bearing seats, shaft bearing seats, spacer surfaces, guide ring surfaces, seal surfaces, seal seat surfaces or any other surfaces that are facing oscillating motions and/or vibrations and/or any forms of corrosion. The imide composition or preservative composition according to the present invention can be used on the surfaces of metal articles but also on non-metal surfaces like plastic material surfaces, glass material surfaces and plastic material surfaces.

Further, the present invention relates to the use of the preservative composition according to the present invention for preventing and/or reducing false brinelling in a roll bearing system, a linear motion system, a plain bearing, a ball bearing, a roller bearing, a gear or a coupling.

The imide composition or preservative composition to be used in accordance with the present invention can be in the form of a grease, a lubricating oil or a paste.

### EXAMPLES

### Example 1

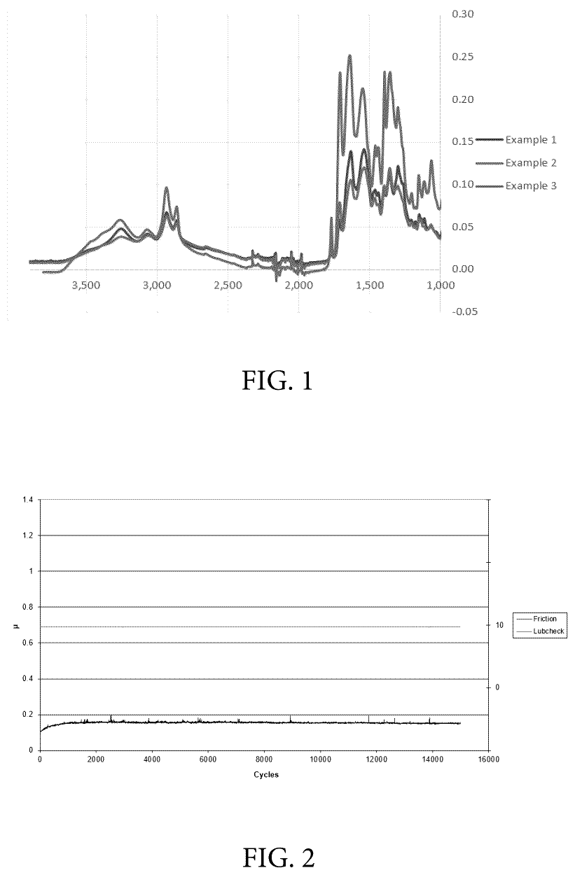

An imide composition in accordance with the present invention was prepared as follows. In a step (a), 0.73 g pyromellitic dianhydride and 0.77 g hexamethylene diamine were mixed together under stirring for 1 minute at a temperature of 50° C. and in the presence of 150 ml N-methyl-2-pyrrolidone as an aprotic polar solvent. The pyromellitic dianhydride (A) and the hexamethylene diamine (B) were applied in a molar ratio of 1:2 (A/B). The product so obtained was dried for 5 min at 120° C. The resulting bulk material was cooled down to room temperature. 1 wt. % of this bulk material was then mixed in a step (b) with 99 wt. % water and heated to 120° C. This product was then applied onto the surface of a steel component and cured for 5 minutes at 120° C. The imide composition so obtained contained 99 wt. % of water and 1 wt. % of an imide having the following IR spectrum of FIG. 1 that shows the presence of poly(2,2,4-/2,4,4-trimethyl hexamethylene pyromellitic imide, pyromellitic acid amide and polyamide.

The imide composition was subjected to the following performance test:

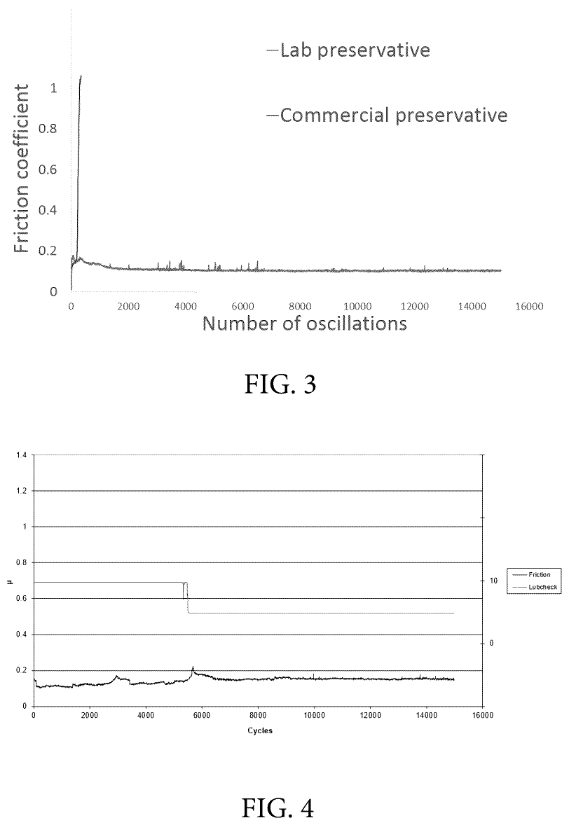

The performance test has been run under oscillating conditions of 100 μm at 20 Hz, and a Hertzian contact pressure of 1 GPa and in contact with an urea grease with 95 cSt at 40° C. The FIGS. 2-4 shows the friction coefficient during the test (the lower line) since in patent applications no colors are used. The performance differentiation compared to commercially available preservatives and rust preventives are shown in FIG. 3. The upper line in FIG. 3 shows identical test results with benchmarked commercial preservatives. Nine preservatives has been tested and all are represented by a fast increase in friction and wear already after a few oscillating cycles as re[resented by the upper line in FIG. 3. The red line represents also the applied urea grease. This grease has a very poor performance in false brinelling and friction and wear is observed immediately after start-up of the test. The performance of the preservative of the example 1, 2 and 3 is shown respectively in FIGS. 2, 3 and 4 and show that false brinelling is resisted even in combination with a poor performing lubricating grease. In other words, whatever type of grease is used the performance is showing a good false brinelling resistance when the embodiments of the present inventions are being applied.

### Example 2

An imide composition in accordance with the present invention was prepared as follows. In a step (a), 2.36 g pyromellitic dianhydride and 2.52 g hexamethylene diamine were mixed together under stirring for 5 minutes at a temperature of 50° C. and in the presence of 50 ml N-methyl-2-pyrrolidone as a aprotic polar solvent. The pyromellitic dianhydride (A) and the hexamethylene diamine (B) were applied in a molar ratio of 1:2 (A/B). The product was dried for 5 minutes at 120° C. The resulting bulk material was cooled down to room temperature. 1 wt. % of this bulk material was mixed in a step (b) with 70 wt. % water and 30 wt. % N-methyl-2-pyrrolidone which mixture was heated to 120 C. This product was then applied onto the surface of a steel component and cured for 5 minutes at 120° C. The imide composition so obtained has an end concentration of less than 1 wt. % diluted in a mixture of 75% by weight of water and 25 wt. % of N-methyl-2-pyrrolidone. The imide composition so obtained contained the same imide as produced in Example 1 of which the IR spectrum is shown in FIG. 1.

The imide composition was subsequently dipped on bearing steel plate which were then subjected to the same performance test as used in Example 1. The performance test has been run under oscillating conditions of 100 μm at 20 Hz, and a Hertzian contact pressure of 1 GPa and in contact with an urea grease with 95 cSt at 40° C. FIG. 3 shows the friction coefficient during the test. The performance test is shown in FIG. 3.

### Example 3

This example was carried out in the same way as Example 1, except that now N-methyl-2-pyrolidone was uses the polar solvent instead of water.

The imide composition was subsequently dipped on bearing steel plate which were then subjected to the same performance test as used in Example 1. The performance test has been run under oscillating conditions of 100 μm at 20 Hz, and a Hertzian contact pressure of 1 GPa and in contact with a urea grease with 95 cSt at 40° C. FIG. 4 shows the friction coefficient during the test.

1. An imide composition obtainable by a process that comprises the steps of:
(a) reacting a dianhydride with a diamine in the presence of a solvent at a temperature in the range of from 20-80° C., wherein the molar ratio of the dianhydride to the diamine is in the range of from 0.25-4, thereby forming an imide precursor; and
(b) subjecting at least part of the imide precursor as formed in step (a) in the presence of a solvent to a heat treatment which is carried out at a temperature in the range of from 80-150° C. to convert at least part of the imide precursor into an imide, thereby forming the imide composition.

2. The imide composition according to claim 1, wherein the dianhydride is selected from the group consisting of pyromellitic dianhydride, perylene tetracarboxylic dianhydride, naphthalene tetracarboxylic dianhydride, ethylene dianhydride, naphthalene dianhydride, penanthrene dianhydride, anthracene dianhydride and benzoquinonetatracarboxylic dianhydride.

3. The imide composition according to claim 2, wherein the dianhydride is pyromellitic dianhydride.

4. The imide composition according to claim 3, wherein the diamine is selected from the group consisting of dodecanediamine, diaminodecane, ethylenediamine, butanediamine, diamineoctane, methanediamine and hexamethylenediamine.

5. The imide composition according to any claim 4, the diamine is hexamethylenediamine.

6. The imide composition according to claim 1, wherein the dianhydride is pyromellitic dianhydride and the diamine is hexamethylenediamine.

7. The imide composition according to claim 1, wherein in step (a) the molar ratio of the dianhydride to the diamide is in the range of from 0.33-1.8. The imide composition according to claim 1, wherein the temperature in step (a) is in the range of from 40-60° C.9. The imide composition according to claim 1, wherein the temperature in step (b) is in the range of from 110-130° C.10. A preservative composition comprising the imide composition according to claim 1.

11. The preservative composition according to claim 10, which is an anti-rust preservative composition or an anti-corrosion preservative composition.

12. A metal article having a coating thereon that comprises the imide composition according to claim 1.

13. A process for preparing an imide composition according to claim 1, comprising the steps of:
(a) reacting a dianhydride with a diamine in the presence of a solvent at a temperature in the range of from 20-80° C., wherein the molar ratio of the dianhydride to the diamine is in the range of from 0.25-4, thereby forming an imide precursor; and
(b) subjecting at least part of the imide precursor as formed in step (a) in the presence of a solvent to a heat treatment which is carried out at a temperature in the range of from 80-150° C. to convert at least part of the imide precursor into an imide, thereby forming the imide composition.

14. Use of the imide composition according to claim 1 to prevent and/or reduce false brinelling in a roll bearing system.

15. Use of the preservative composition according to claim 10 to prevent and/or reduce false brinelling in a roll bearing system.

16. A metal article having a coating comprising the preservative composition according to claim 10.

17. Use of the preservative composition according to claim 11 to prevent and/or reduce false brinelling in a roll bearing system.
